(19) United States
(12) Patent Application Publication
(10) Pub. No.: US 2011/0073241 A1
(43) Pub. Date: Mar. 31, 2011

(54) METHOD AND APPARATUS FOR SEPARATING PROTECTIVE TAPE

(76) Inventors: Yukitoshi Hase, kameyama-shi (JP); Masayuki Yamamoto, Osaka (JP)

(21) Appl. No.: 12/877,274

(22) Filed: Sep. 8, 2010

(30) Foreign Application Priority Data
Sep. 29, 2009 (JP) 2009-224688

(51) Int. Cl. B32B 38/10; B32B 38/04; B32B 38/00

(52) U.S. Cl. 156/79; 156/584; 156/248; 156/85

(57) ABSTRACT

A tape separation mechanism suction-holds a chip into which a substrate is diced that is adhesively held on a mount frame via a protective tape, and moves to place the chip in a mounting position of the substrate on a substrate holding stage. A heater heats via a head the protective tape joined to a surface of the chip at the mounting position that loses its adhesive force due to foam and expansion through heating. Thereafter, the tape separation mechanism moves upward while suction-holding the protective tape, thereby separating and removing the protective tape from the chip.

### BACKGROUND OF THE INVENTION

1. Field of the Invention

This invention relates to a protective tape separating method and apparatus to separate a protective tape that protects a circuit surface of a substrate such as a semiconductor wafer, a circuit board, and an electron device (for instance, an LED (Light-emitting diode) and a CCD (charge coupled device).) More particularly, this invention is directed to a technique of separating the protective tape after mounting a chip produced by dicing of the substrate into a predetermined shape on the substrate in a given position.

2. Description of the Related Art

Typically, numerous components are formed on a surface of a semiconductor wafer (hereinafter simply referred to as a “wafer”), and then grinding is performed to a rear face of the wafer in a back grinding process. Next, the wafer is diced into each component in a dicing process. The wafer tends to be thinned to have a thickness of 100 μm to 50 μm or even less in recent years with a need for a high density package.

Here, the protective tape is joined to the surface of the wafer upon thinning of the wafer in the back grinding process for the purposes of protection of the circuit surface of the wafer, prevention of the wafer from being subject to grinding stress upon back grinding, and reinforcement of the thinned wafer through the back grinding.

After the back grind process, a separation adhesive tape is joined to the protective tape on the wafer in a mount frame that is adhesively held on a ring frame via a dicing tape. Thereafter, the separation adhesive tape is separated, thereby separation of the protective tape from the surface of the wafer together with the separation adhesive tape. See Japanese Patent Publication No. 2006-165385.

The foregoing conventional method, however, has the following problem. That is, in the foregoing conventional method of separating the protective tape, the protective tape is separated from the surface of the wafer, and thereafter a dicing process is performed to the wafer. Accordingly, the following problem arises. That is, powder dust or rinse water may adhere to the surface of the wafer during the dicing process, which leads to a contaminated exposed circuit surface.

Moreover, in the foregoing conventional method, the protective tape is separated while being held on the mount frame. Thereafter, the chip is transported to a subsequent process with a circuit surface or electrodes thereof being exposed, or a head of a chip mounter directly comes into contact with the circuit surface to mount the chip on the substrate as an adherend in a given position. In such cases, the circuit surface may be contaminated or broken. As a result, such problem as poor mount or bonding may arise.

Where the chip is an LED, even the chip of non-defective may be determined to have measured intensity lower than a reference value in quality inspection due to rinse water or an oil film that is adhered to the surface during transportation. Here, a further problem may arise that the chip is consequently determined as material defects.

### SUMMARY OF THE INVENTION

This invention has one object to allow a diced chip to be mounted on an adherend with no contamination on a circuit surface of the diced chip.

The invention discloses a method of separating a protective tape joined to a surface of a substrate. The method includes separating the protective tape joined to a chip into which the substrate having the protective tape joined thereto is diced in a predetermined shape after mounting the chip on an adherend.

With the method of separating the protective tape, the circuit surface is not to be contaminated, since the surface of the chip is protected by the protective tape until mounted on the adherend. For instance, the protective tape is preferably separated after a die bonding process or prior to a wire bonding process. In such cases, the electrodes electrically connected are protected with the protective tape just before connected to the electrodes or wires on an adherend side. Thus, the electrodes enable positive connection having no contamination or damage.

In the foregoing method, a protective tape having a heat separation property may be adopted. For instance, examples of such protective tape include one having an adhesive layer of thermal foam, and one having a heat-shrinkable adhesive layer that bends backward in a given uniaxial direction.

Separating of the protective tape preferably includes the following steps of mounting the chip on the adherend in a given position with a suction transport mechanism provided with a heater, heating the protective tape having an adhesion layer that foams and expands through heating with the suction transport mechanism in the given position, and separating the protective tape from the chip by suction-holding the protective tape having a reduced adhesive force in the heating step upon retracting of the suction transport mechanism.

Here, in the case of the protective tape having a heat separation property, the heating step preferably includes moving upward the suction transport mechanism depending on variations of the protective tape in direction where thickness of the protective tape increases through heating.

According to this method, even when the adhesion layer of the protective tape is foamed and expanded or the protective tape bends backward due to heating of the protective tape, upward movement of the suction transport mechanism will cancel pressure generated at this time between the chip and the suction transport mechanism. Accordingly, no excessive pressure is applied to the chip, which results in no damage in the chip.

The protective tape may be an ultraviolet curable type protective tape. Here, the method preferably includes the steps of mounting the chip on the adherend in a given position with a suction transport mechanism, emitting ultraviolet rays to an ultraviolet curable protective tape in the given position, and separating the protective tape having a reduced adhesive force during the step of emitting ultraviolet rays from the chip.

Moreover, the suction transport mechanism preferably includes an ultraviolet-ray irradiation unit. The step of emitting ultraviolet rays preferably further includes mounting the chip in the given position with the suction transport mechanism and emitting ultraviolet rays to the protective tape with the ultraviolet-ray irradiation unit. The step of separating the protective tape preferably further includes separating the protective tape from the chip by suction-holing the protective tape having a reduced adhesive force with emitting of the ultraviolet rays upon retracting of the suction transport mechanism.

This invention also discloses a protective tape separating apparatus that separates a protective tape joined to a surface of a substrate. The apparatus includes a suction transport mechanism that suction-holds a chip into which the substrate is diced in a predetermined shape with the protective tape joined thereto for mounting the chip on an adherend in a given position, an adhesive force reduction section that reduces an adhesive force in the protective tape joined to the chip in the given position, and a separation mechanism that separates the protective tape having a reduced adhesive force from the chip.

With this configuration, the suction transport mechanism mounts the chip with the protective tape joined thereto on the adherend in the given position. Thereafter, the adhesive force is reduced to separate the protective tape from the chip. Accordingly, the foregoing method may suitably be performed.

Here, where the protective tape is of a heat-separation property having thermal foam or a heat-shrinkable adhesive layer that bends backward in a given uniaxial direction, the adhesive force reduction section is preferably a heater. The heater is preferably provided in the suction transport mechanism.

With this configuration, the suction transport mechanism may perform a series of processes from the step of mounting the chip on the adherend in the given position while suction-holding the chip to the step of separating the protective tape. Consequently, the protective tape having a reduced adhesive force is not to be dispersed to contaminate the adherend. In addition, the apparatus may be simplified in configuration.

The apparatus having the foregoing configuration preferably includes a controller that moves the suction transport mechanism upward depending on variations of the protective tape in direction where thickness of the protective tape increases through heating.

With this configuration, even when the adhesion layer of the protective tape is foamed and expanded or the protective tape bends backward due to heating of the protective tape, upward movement of the suction transport mechanism will cancel pressure generated at this time between the chip and the suction transport mechanism. Accordingly, no excessive pressure is applied to the chip, which results in no damage in the chip.

Moreover, where the protective tape is an adhesive tape of an ultraviolet curable type, the adhesive force reduction section is preferably an ultraviolet-ray irradiation unit.

The ultraviolet-ray irradiation unit is preferably provided in the suction transport mechanism.

In this configuration, it is more preferable that the suction transport mechanism retracts while suction-holding the protective tape having a reduced adhesive force with the suction transport mechanism, whereby the separation mechanism separates the protective tape from the chip.

The apparatus having the foregoing configuration may perform a series of processes from the step of mounting the chip on the adherend in the given position while suction-holding the chip to the step of separating the protective tape. Consequently, the protective tape having a reduced adhesive force is not to be dispersed to contaminate the adherend. In addition, the apparatus may be simplified in configuration.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a mount frame.

FIG. 2 is a top view of a protective tape separating apparatus.

FIG. 3 is a front view of the protective tape separating apparatus.

FIG. 4 is a top view of a frame transport mechanism.

FIG. 5 is a front view of the frame transport mechanism.

FIG. 6 is a front view of a chuck table.

FIG. 7 is a partial cross-sectional view of a head.

FIGS. 8 to 13 are explanatory views each showing operations of separating the protective tape according to Embodiment 1.

FIG. 14 is an explanatory view showing an operation of separating an adhesive tape according to modification.

FIG. 15 is a front view of a modified apparatus using an ultraviolet curable protective tape.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One embodiment of this invention will be described hereunder with reference to the drawings.

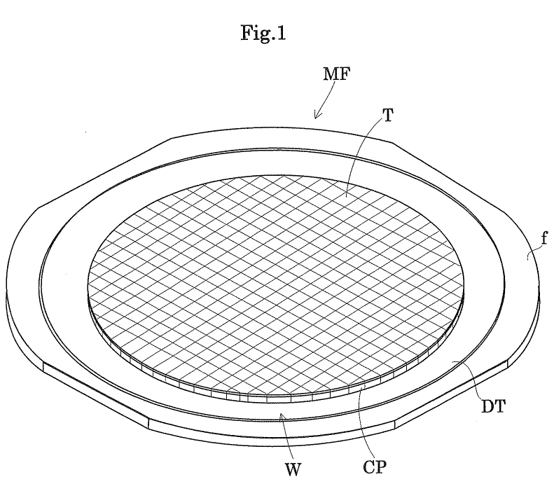

Here, in this embodiment, a semiconductor wafer will be described as one example of a substrate. As shown in FIG. 1, a semiconductor wafer W (hereinafter simply referred to as a “wafer W”) is subject to back grinding and dicing processes with a protective tape T joined thereto that protects a circuit pattern on the wafer W, and diced into a chip CP. Two or more diced chips CP in a substrate size are adhesively held on a ring frame f via an adhesive tape DT (dicing tape), and processed as a mount frame MF.

Here, the protective tape T has an adhesion layer of thermal foam in a tape base material that loses its adhesive force due to foaming and expansion through heating.

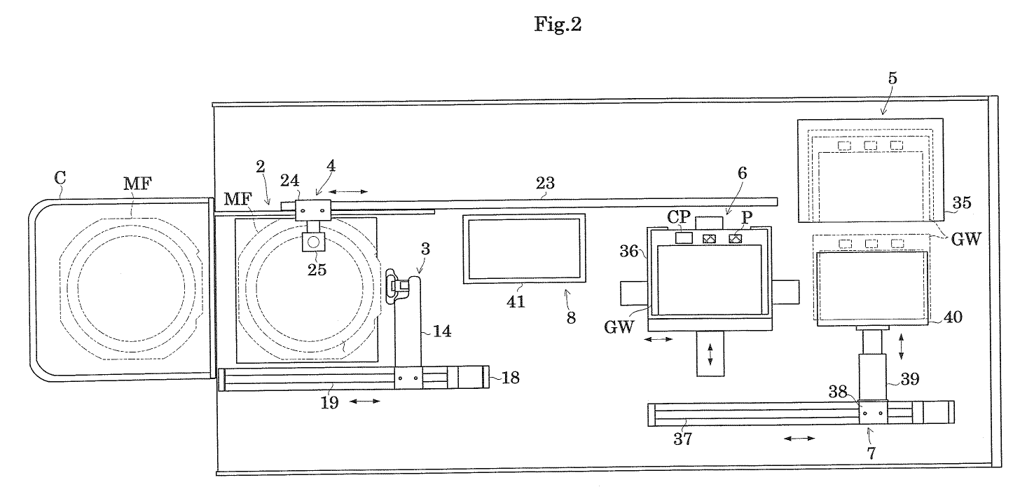

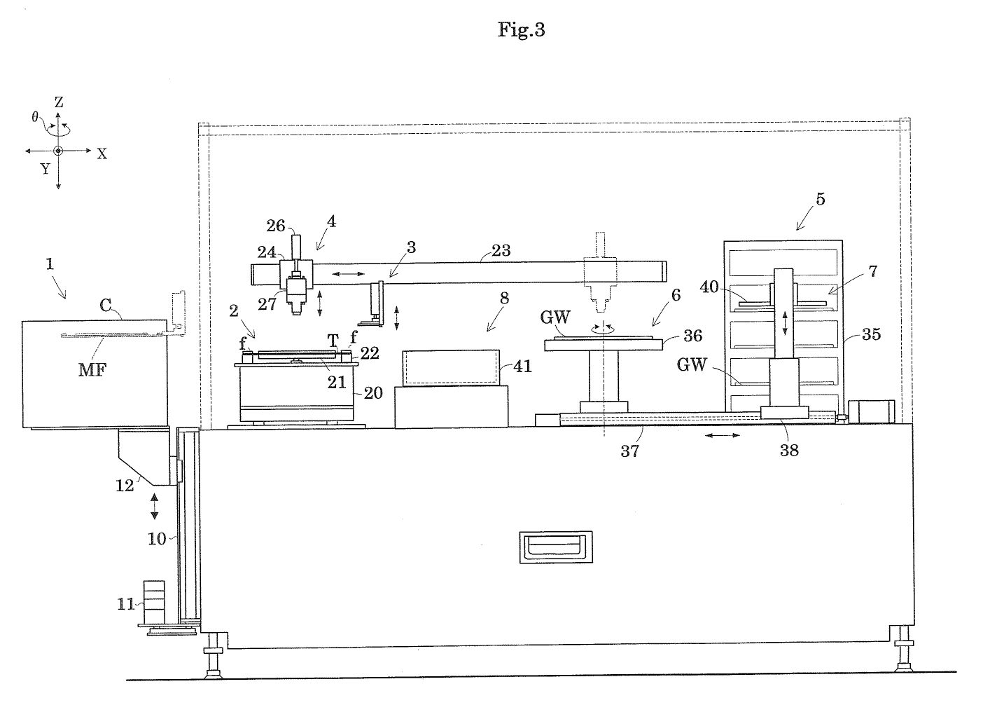

FIGS. 2 and 3 show a schematic configuration of a protective tape separating apparatus and processes of separating a protective tape for accomplishing the method according to this invention.

The protective tape separating apparatus is formed of a cassette mounting section 1, a frame transport mechanism 3, a tape separation mechanism 4, a substrate housing section 5, a substrate transport mechanism 7, and a tape collecting section 8. The cassette mounting section 1 has a cassette C mounted thereon that houses mount frames MF at a predetermined pitch in a stack manner. The frame transport mechanism 3 pulls out the mount frame MF from the cassette C and places the mount frame MF on a chuck table 2, and houses the mount frame MF with the protective tape PT separated therefrom into the cassette C. The tape separation mechanism 4 suction-holds the chip CP from the mount frame MF suction-held with the chuck table 2 and transports and mount the chip CP in a given position on a substrate GW in a subsequent step, and separates the protective tape T from the chip CP. The substrate housing section 5 houses the substrate GW at a predetermined pitch in a stack manner. The substrate transport mechanism 7 pulls out the substrate GW from the substrate housing section 5 and places the substrate GW on a holding table 6, and houses the substrate GW on the holding table 6 into the substrate housing section 5. The tape collecting section 8 collects the protective tape T that is separated from the chip CP. Next, each component will be described in detail.

The cassette mounting section 1 has an upright rail 10 and a lifting table 12, as shown in FIG. 3. The upright rail 10 is fixedly coupled to an apparatus framework. The lifting table 12 moves upward and downward in a screw-feed manner by a drive mechanism 11 such as a motor along the upright rail 10. Accordingly, the cassette mounting section 1 allows the mount frame MF placed on the lifting table 12 to move vertically in a pitch feed manner.

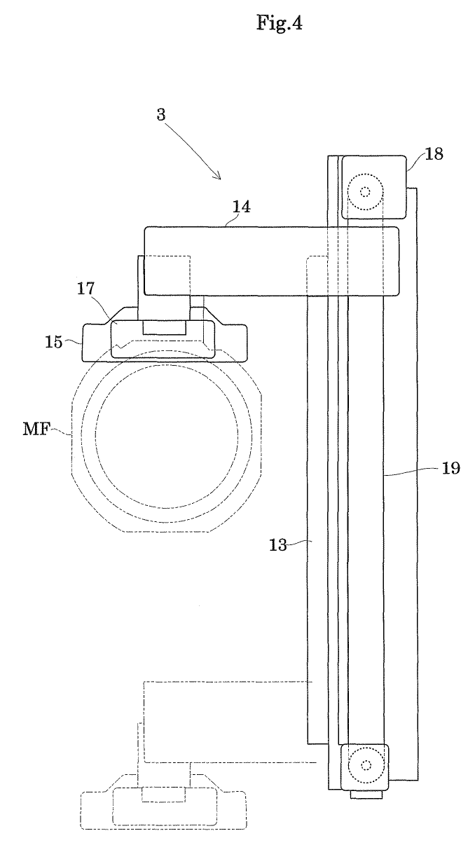

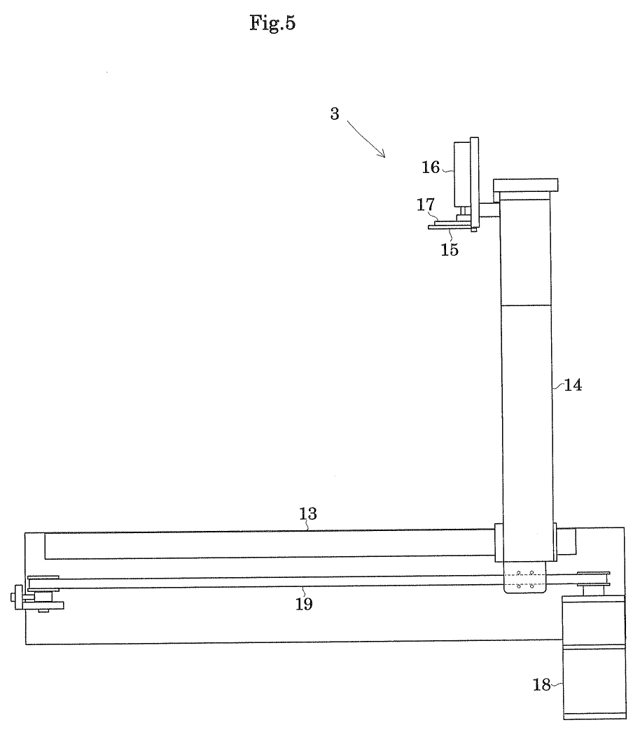

As shown in FIGS. 4 and 5, the frame transport mechanism 3 has a chuck piece 17 provided on a movable table 14 that moves horizontally along a guide rail 13. A fixed receiving piece 15 and a cylinder 16 open the chuck piece 17. Herein, the fixed receiving piece 15 and chuck piece 17 vertically grasp one end of the mount frame MF. Moreover, the movable table 14 has a bottom side coupled to a belt 19 that is turned by a motor 18. Accordingly, the movable table 14 reciprocates upon forward and backward operation of the motor 18.

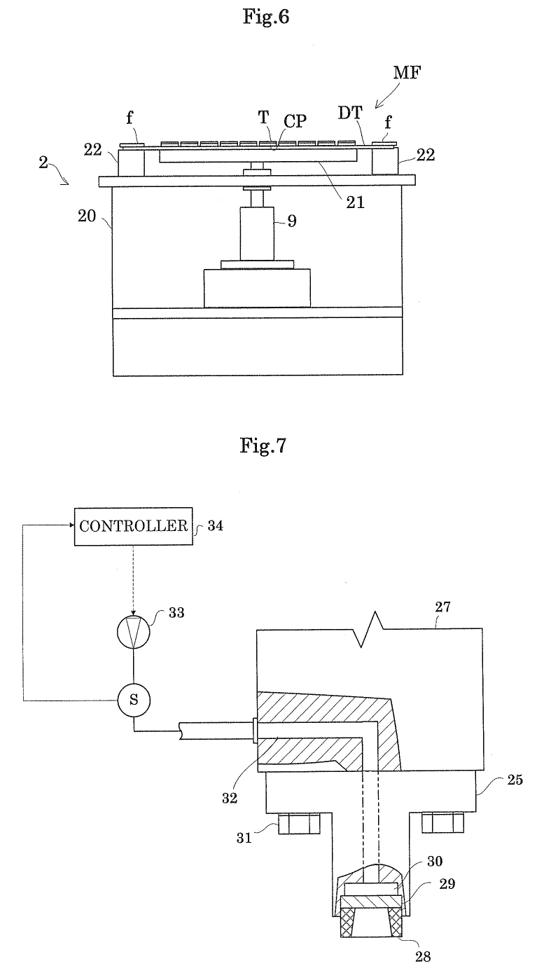

As shown in FIG. 6, the chuck table 2 has a wafer holding table 21 and a frame holding table 22 that holds the ring frame f. The wafer holding table 21 suction-holds the wafer W in the mount frame MF on a movable table 20. Moreover, as shown in FIG. 3, the movable table 20 is movable in two horizontal axes directions (X, Y) and a vertical direction (Z), and about a Z-axis (θ).

The wafer holding table 21 moves upward and downward with an actuator 9. Specifically, the wafer holding table 21 moves upward to a given level such that a surface level of the wafer W is higher than that of the ring frame f. Consequently, the adhesive tape DT extends to separate the chip CP individually.

As shown in FIGS. 2 and 3, the tape separation mechanism 4 has a movable table 24, a head 25, and a cylinder 26. The movable table 24 moves horizontally along a guide rail 23. The head 25 is provided at a tip end of an arm that extends from the movable table 24. The cylinder 26 moves the head 25 upward and downward. Here, the tape separation mechanism 4 also serves as the suction transport mechanism of this invention.

As shown in FIG. 7, the head 25 is formed of a ceramic holder 28, a heater 29, and a pad 30 in turn from lower of a metal body 27. Here, the holder 28 is attached on the body 27 via bolts 31. In addition, a channel 32 is provided that penetrates from the body 27 to the pad 30 for communication with an external pump 33 on a body side. That is, the controller 34 performs negative pressure control of the pump 33, whereby the head suction-holds the chip CP with the tip end thereof. Moreover, the controller 34 performs positive pressure control of the pump 33, thereby discharging the separated protective tape T to be suction-held. Here, the tape separation mechanism 4 corresponds to the separation mechanism of this invention. The heater 29 corresponds to the adhesive force reduction section of this invention.

As shown in FIGS. 2 and 3, the substrate housing section 5 has a substrate housing magazine 35 that houses in a stack manner unprocessed substrates GW and substrates GW with the chip CP mounted thereon. Here, examples of the substrate GW include substrates such as a glass substrate for a liquid crystal display and a flexible substrate that have a circuit pattern and electrodes formed thereon.

The holding table 6 has a substrate holding stage 36 that suction-holds the substrate GW. The substrate holding stage 36 is movable in two horizontal axes directions (X, Y) and a vertical direction (Z), and about a Z-axis (θ).

The substrate transport mechanism 7 has a guide rail 37, an arm 39, and a substrate holder 40. The guide rail 37 is arranged on an apparatus base. The arm 39 is provided in a movable table 38 that moves along the guide rail 37, and moves backward/forward and upward/downward. The substrate holder 40 that is attached at the tip end of the arm 39 suction-holds the substrate GW.

The tape collecting section 8 has a collection box 41. The collection box 41 is provided between the chuck table 2 and the holding table 6 and has an opening directed upward below a movement path of the tape separation mechanism 4.

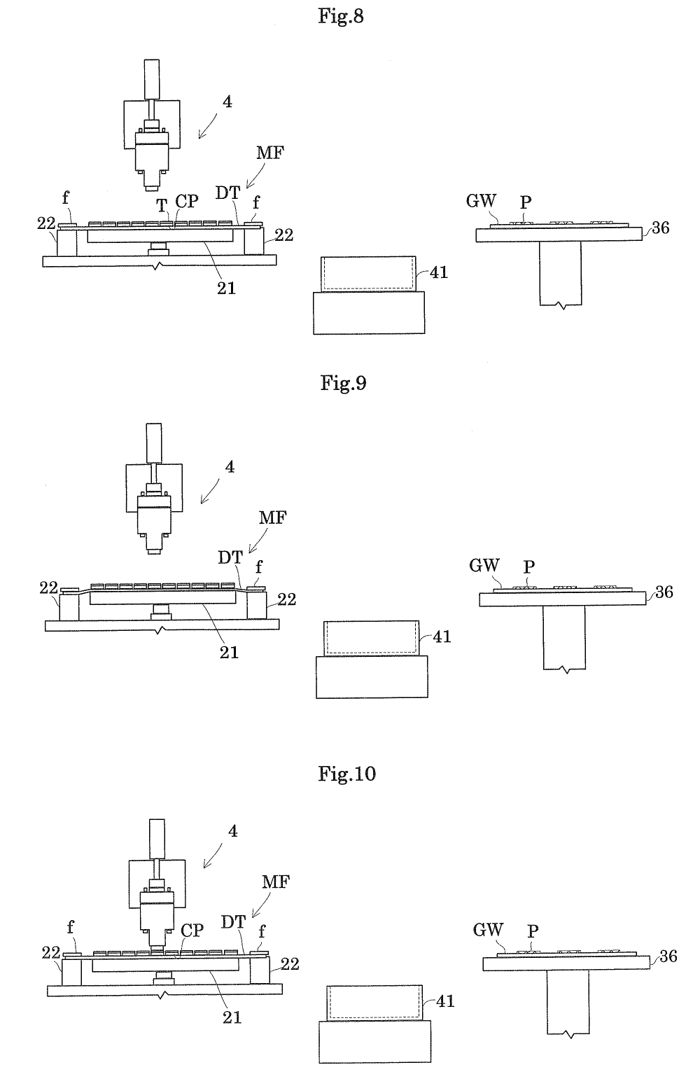

Next, with reference to FIGS. 8 to 12, description will be given of a series of basic operations for separating the protective tape T from the chip using the apparatus in the foregoing embodiment.

The frame transport mechanism 3 is in a standby position, and moves to a position of pulling out the mount frame MF. The frame transport mechanism 3 pulls out the mount frame MF from the cassette C while holding the mount frame MF and moving backward. Here, the mount frame MF is housed in the cassette C in a stack manner with the surface of the wafer W directed upward. The mount frame MF is moved to a feeding position of the chuck table 2.

The frame transport mechanism 3 in the feeding position moves downward to a given level to release the chuck piece 17, and places the mount frame MF on the chuck table 2.

As shown in FIG. 8, the chuck table 2 having the mount frame MF placed thereon suction-holds an entire rear face of the mount frame MF. As shown in FIG. 9, the wafer holding table 21 moves upward to a given level to push up the chip CP along with the adhesive tape DT for separating the chip CP individually. Thereafter, the wafer holding table 21 moves downward to its original level.

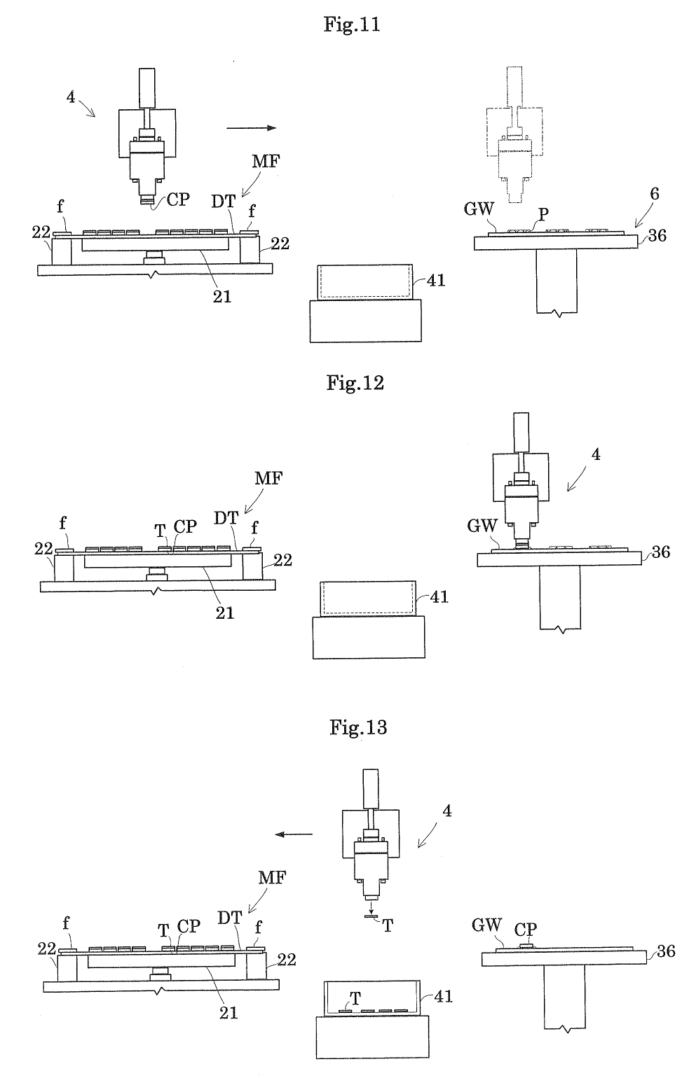

Thereafter, the movable table 20 operates to align the chip CP to be transported into a suction-holding position of the tape separation mechanism 4. As shown in FIG. 10, the tape separating mechanism 4 moves downward to contact the head 25 to the chip CP. Suction-holding is confirmed, and then as shown in FIG. 11, the tape separation mechanism 4 moves upward and horizontally to transport the chip CP to the holding table 6.

Upon transportation of the mount frame MF, the substrate transport mechanism 7 operates to suction-hold and transport the substrate GW to be processed from the substrate housing magazine 35 with the substrate holder 40. The substrate GW is placed on the substrate holding stage 36.

The substrate holding stage 36 suction-holds the substrate GW, and thereafter aligns a mounting portion with a downward movement position of the tape separating mechanism 4.

When the tape separation mechanism 4 reaches to a holding table 6 side, a sensor identifies the mounting portion. Thereafter, the separation mechanism 4 moves downward to mount the chip CP in a given position on the substrate GW, as shown in FIG. 12. Here, a conductive paste P, etc., is applied in advance to the mounting portion of the substrate. The chip CP may be electrically connected and adhered to the mounting portion not only via the conductive paste P but also via a conductive film. Where electrical connection is not required, a non-conductive paste or non-conductive film may be used.

The tape separation mechanism 4 stops in the mounting position. The heater 29 heats the protective tape T and conductive paste P while the tape separation mechanism 4 suction-holds the chip CP. The adhesion layer of the protective tape T loses its adhesive force due to foaming and expansion through heating with the heater 29. The conductive paste P hardens and adheres to the substrate.

The controller 34 controls the tape separation mechanism 4 as to move upward intermittently or continuously during a heating process in accordance with variations in thickness of the protective tape T determined in advance from types, heating temperatures, and durations for heating of adhesion layers used for the protective tape T. Specifically, the adhesive tape has an increased thickness due to foaming and expansion of the adhesion layer. Thus, the tape separation mechanism 4 is controlled as to move upward such that the thinned chip CP sandwiched between the head 25 and the substrate GW is not damaged due to excessive pressure applied thereto.

The tape separation mechanism 4 may be controlled as to move upward under a program determined from results of reproductive experiments or simulation conducted in advance. Alternatively, the tape separation mechanism 4 may be controlled as to move to a level in accordance with detected results by the sensor on the surface level of the protective tape T.

Upon completion of heating to the adhesive layer for a given time, the controller 34 confirms that the sensor S shown in FIG. 7 detects no poor suction. The tape separation mechanism 4 moves upward while suction-holding the protective tape T for starting movement towards a position to pull out a new chip CP. When passing above the collection box 41 during this movement, the controller 34 controls positive pressure of the pump 33. Consequently, the separated protective tape T that is suction-held with the head 25 is discharged toward the collection box 41, as shown in FIG. 13.

The substrate transport mechanism 7 pulls out the substrate GW with the chip CP mounted thereon from the substrate holding stage 36, and houses the substrate GW in its original position in the substrate housing magazine 35. Thereafter, the substrate transport mechanism 7 transports a new substrate GW.

As mentioned above, separation of the protective tape T with respect to a chip CP is completed. The same process as above is to be performed hereinafter to the chips in the mount frame MF. Moreover, separation of the protective tape T with respect to all the chips CP is completed, and then the same process as above is to be repeatedly performed to every mount frame MF housed in the cassette C.

According to the foregoing configuration, the circuit surface is not to be contaminated or damaged, since the surface of the chip CP is protected by the protective tape T until mounted on the substrate GW. Moreover, even when the protective tape T foams and expands to have an increased thickness in a height direction, no chip CP will be damaged and the protective tape T may also be prevented from scattering due to poor suction.

This invention is not limited to the foregoing embodiments, but may be modified as follows.

With the apparatus in the foregoing exemplary embodiment, a protective tape T having a heat-shrinkable adhesive layer that bends backward in a given uniaxial direction through heating may be adopted instead of the protective tape T having an adhesive layer of a heat-separation property that foams and expands through heating.

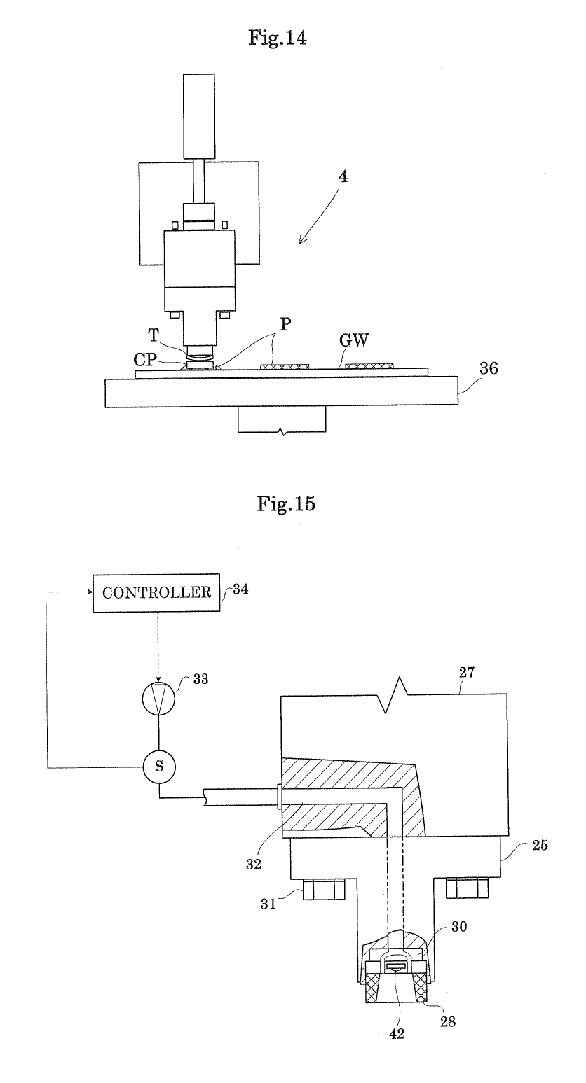

In this case, separation with respect to a given chip CP is performed in the same processes as in the foregoing embodiment. Specifically, the tape separation mechanism 4 mounts the chip CP in a given position on the substrate GW. Thereafter, the head 25 heats the protective tape T while suction-holding at the position. As shown in FIG. 14, the controller 34 controls the tape separation mechanism 4 as to move upward intermittently or continuously during a heating process in accordance with an amount of bending of the protective tape T determined in advance from types, heating temperatures, and durations for heating of adhesion layers used for the protective tape T. In addition, a suction force of the head 25 is controlled as to increase simultaneously.

Specifically, even when the protective tape bends backward due to shrinkage of the adhesive layer thereof and has an increased thickness in a height direction, no excessive pressure is applied to the chip CP that is sandwiched between the head 25 and the substrate GW. In other words, the head 25 is controlled as to move upward with no chip CP being damaged. Simultaneously, a suction force of the head 25 is controlled as to increase in accordance with an amount of bending of the protective tape such that the protective tape does not bend backward to have a reduced contact area.

Upon completion of separating the protective tape T from the chip CP through heating for a predetermined time, the protective tape T is discharged from the head 25 toward the collection box 41 in the process where the head 25 returns to its transport position with the protective tape T suction-held thereon.

With this configuration, even when the protective tape T bends backward to have an increased thickness in a height direction, no chip CP will be damaged and the protective tape T may also be prevented from scattering due to poor suction.

An ultraviolet curable adhesive tape may be adopted as the protective tape T instead of the protective tape T of a heat-separation property as in each of the foregoing embodiments.

In this case, the tape separation mechanism 4 has the head 25 formed of a permeable member. In addition, an ultraviolet LED 42 is embedded in the head 25 as shown in FIG. 15. Here, the ultraviolet LED 42 corresponds to the ultraviolet irradiation unit of this invention.

With this configuration, the tape separation mechanism 4 mounts the chip CP in a given position on the substrate GW. Thereafter, the head 25 irradiates the protective tape T with ultraviolet rays at the position. Upon reduction of the adhesive force due to hardening of the adhesive layer with ultraviolet application for a predetermined time, the tape separation mechanism 4 moves upward while suction-holding the protective tape T. Consequently, the protective tape T is separated from the chip CP.

In each of the foregoing embodiments, a die bonding tape may be adopted instead of the conductive paste P.

In this case, the die bonding tape instead of the protective tape T is joined to the circuit surface of the wafer W. The wafer W is adhesively held on the ring frame f via the adhesive tape DT with the circuit surface thereof directed downward to produce a mount frame MF. A dicing process is performed to the mount frame MF in this state including the die bonding tape, whereby the apparatus in the foregoing embodiments allow handling of the mount frame MF. In other words, face down bonding may be performed with respect to the chip CP on the substrate GW.

In each of the foregoing embodiments, die bonding is performed with respect to the chip CP on the substrate GW, and thereafter the protective tape T is separated from the chip CP. Alternatively, the following may be performed. That is, the tape separation mechanism 4 in the foregoing exemplary apparatus is adopted. The tape separation mechanism 4 mounts the chip CP in a given position on the substrate GW that is held on the substrate holding stage in a wire bonding process. Then, the tape separation mechanism 4 separates the protective tape T just before performing wire bonding to the chip CP.

With this configuration, the protective tape T protects electrodes on the chip CP just before performing wire bonding, thereby avoiding contamination of the chip CP. Consequently, wires may be bonded the electrodes with high accuracy.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of separating a protective tape joined to a surface of a substrate, comprising the step of:
separating the protective tape joined to a chip into which the substrate having the protective tape joined thereto is diced in a predetermined shape after mounting the chip on an adherend.

2. The method of separating the protective tape according to claim 1, wherein
the protective tape is separated after a die bonding process.

3. The method of separating the protective tape according to claim 1, wherein
the protective tape is separated prior to a wire bonding process.

4. The method of separating the protective tape according to claim 1, further comprising the steps of:
mounting the chip on the adherend in a given position with a suction transport mechanism provided with a heater;
heating the protective tape having an adhesion layer that foams and expands through heating with the suction transport mechanism in the given position; and
separating the protective tape from the chip by suction-holding the protective tape having a reduced adhesive force in the heating step upon retracting of the suction transport mechanism.

5. The method of separating the protective tape according to claim 4, wherein the step of heating comprises moving upward the suction transport mechanism depending on variations of the protective tape in direction where thickness of the protective tape increases due to foam and expansion through heating.

6. The method of separating the protective tape according to claim 1, further comprising the steps of:
mounting the chip on the adherend in a given position with a suction transport mechanism provided with a heater;
heating the protective tape having a heat-shrinkable adhesive layer that bends backward in a given uniaxial direction with the suction transport mechanism in the given position; and
separating the protective tape from the chip by suction-holding the protective tape having a reduced adhesive force in the heating step upon retracting of the suction transport mechanism.

7. The method of separating the protective tape according to claim 6, wherein the step of heating comprises moving upward the suction transport mechanism depending on variations of the protective tape in direction where thickness of the protective tape increases due to bending backward through heating.

8. The method of separating the protective tape according to claim 1, further comprising the steps of:
mounting the chip on the adherend in a given position with a suction transport mechanism;
emitting ultraviolet rays to an ultraviolet curable protective tape in the given position; and
separating the protective tape having a reduced adhesive force during the step of emitting ultraviolet rays from the chip.

9. The method of separating the protective tape according to claim 8, wherein
the suction transport mechanism comprises an ultraviolet-ray irradiation unit,
the step of emitting ultraviolet rays comprises mounting the chip in the given position with the suction transport mechanism and emitting ultraviolet rays to the protective tape with the ultraviolet-ray irradiation unit, and
the step of separating the protective tape comprises separating the protective tape from the chip by suction-holing the protective tape having a reduced adhesive force with emitting of the ultraviolet rays upon retracting of the suction transport mechanism.

10. A protective tape separating apparatus that separates a protective tape joined to a surface of a substrate, comprising:
a suction transport mechanism that suction-holds a chip into which the substrate is diced in a predetermined shape with the protective tape joined thereto for mounting the chip on an adherend in a given position;
an adhesive force reduction section that reduces an adhesive force in the protective tape joined to the chip in the given position; and
a separation mechanism that separates the protective tape having a reduced adhesive force from the chip.

11. The protective tape separating apparatus according to claim 10, wherein
the adhesive force reduction section is a heater that heats an adhesive layer of thermal foam in the protective tape.

12. The protective tape separating apparatus according to claim 11, wherein
the heater is provided in the suction transport mechanism.

13. The protective tape separating apparatus according to claim 11, comprising
a controller that moves the suction transport mechanism upward depending on variations of the protective tape in direction where thickness of the protective tape increases through heating.

14. The protective tape separating apparatus according to claim 10, wherein
the adhesive force reduction section is a heater that heats the protective tape having a heat-shrinkable adhesive layer that bends backward in a given uniaxial direction.

15. The protective tape separating apparatus according to claim 14, wherein
the heater is provided in the suction transport mechanism.

16. The protective tape separating apparatus according to claim 14, comprising
a controller that moves the suction transport mechanism upward depending on variations of the protective tape in direction where thickness of the protective tape increases through heating.

17. The protective tape separating apparatus according to claim 10, wherein
the adhesive force reduction section is an ultraviolet irradiation unit that emits ultraviolet rays to an ultraviolet curable protective tape.

18. The protective tape separating apparatus according to claim 17, wherein
the ultraviolet-ray irradiation unit is provided in the suction transport mechanism.

19. The protective tape separating apparatus according to claim 10, wherein
the suction transport mechanism retracts while suction-holding the protective tape having a reduced adhesive force with the suction transport mechanism, whereby the separation mechanism separates the protective tape from the chip, and transports the protective tape to a given position for disposal.
